(19) United States
(12) Patent Application Publication
(10) Pub. No.: US 2003/0159332 A1
(43) Pub. Date: Aug. 28, 2003

(54) Dynamic snag resistant fishing weight

(76) Inventor: Huey Thomas Crochet, Livingston, TX (US)

Correspondence Address: HUEY THOMAS CROCHET, P O BOX 344, ONALASKA, TX, 77360, US

(21) Appl. No.: 10/083,771

(22) Filed: Feb. 27, 2002

(51) Int. Cl. A01K 91/00; A01K 93/00; A01K 95/00

(52) U.S. Cl. 43/44.87

(57) ABSTRACT

The dynamic snag resistant fishing weight is designed to perform as a static weight and also provide snag resistant performance. Said weight will greatly enhance the capabilities of the tightline fisherperson who wishes to fish in and around stumps and brush laden areas. Said weight is 6 inches long and one quarter inch in diameter weighing approximatley one and one-half ounces. A spin manuever performed by said weight upon impact with obstacles is responsible for the snag resistant performance. Said weight is an all metal construct and completely environmentally safe. The horizontal plane of operation allows for fast steady retrieves from long casts. This weight is used as any ordinary weight is used.

### BACKGROUND

1. Field of Invention

This invention relates to the field of fishing, specifically fishing weights.

2. Description of Prior Art

Prior Art 1.

To my knowledge, the only fishing weight clamining snag resistant performance is, a patent pending slip sinker. It is packaged as the Lindy Rattlin no-snag slip sinker,and was developed by the Linder brothers of In-Fisherman Magazine at box 973, 1110 Wright Street Brainerd, Minn. 56401 WWW. lindy little joe. com. Rattles are well known and effective fish attractants for some but not all species of fish. Bass and crappie are two to which rattles are an attractant under windy or choppy conditions. These same fish may be spooked under calm, still conditions. Some other species will be repelled by rattles under any conditions. Given this commonly known phenomenon, it is clear that this weight is better suited to certain of the more popular scaled gamefish and is designed specifcally for them. The use of balsa wood for approximately 1/3 of the body of the weight causes a conflict of intrest with the static portion and speaks to extreme specialization. This very light wood makes the weight stand on end vertically at the slightest applied pressure from the line. This means that its value as a static weight is almost nil. The explantion of the mode of operation on the packaging states that this product will dance and snake its way through snags by pivoting and shaking itself loose from rocks, weeds and brush. This is a vertical mode of operation which is suited only to short casts as performed by bass fishermen. A steady fast retrieve takes the weight out of the preffered vertical mode and greatly increasing the possibility of snagging. The vertical mode of snag resistance is accomplished through a series of very short jerks and hops over a relatively short distance. A catfisherman will commonly make long casts easily 2 to 5 times the distance of the bass fisherman. This increases the odds of snagging, hopping and jerking this weight from such a distance would be a would be a slow and tedious process. One not many catfishman would attempt on a regular basis. The fragile structure of this weight makes it very likely to be mishapen and unusable after an actual snag situation where extraction was accomplished by applied force. The tightline method is one whereby the line is made taut between the weight and the tip of the rod and left in this state for what can be long periods of time. The fact that this weight will stand on end, because of the conflict of intrest supplied by the balsa wood, means that it has little value to the tightline fisherman.

### OBJECTS AND ADVANTAGES

Accordingly some objects and advantages of the Dynamic Snag rsistant fishing Weight are:

(A) To provide a weight that can be used equally well by the majority of sport fisherman.

(B) To provide a product of sufficient ststic weight to allow for the tightline method of fishing.

(C) To provide a weight with a horizontal, rather than vertical mode of snag resisitance operation to allow for long casts and retrieves.

(D) To provide a weight with excellent snag resistant performance.

(E) To provide a weight incapable of spooking fish by purposley making sounds.

(F) To provide a product with extreme strength of structure,to make extractions a more likely outcome to on actual snag situation.

(G) To provide the fishing public with a choice of products in the market place, thereby reducing cost to the comsumer through competition.

### OPERATION OF INVENTION

The Snag Resistant fishing weight is designed primarily for the tightline method of fishing. The tightline method requires, that a tightline is achieved between the weight,and the tip of the rod. This condition is maintained until a fish is hooked or steals the bait. At this point the line is reeled in, and a weight with Snag Resistance performance, becomes a great asset to the person fishing. The weight operates by performing a spin, upon contact with obstacles.

The rounded face of the angled portion of the weight makes first contact and slips to one side initiating a spin bottom to top. A right angle to the length of the weight. Since the line is always over and across any potential snag, the level of line attachment is the level of clearance over the obstacle. As the longer, lower portion of the weight, swings up to the obstacle is cleared, but the impact of collison with obstacles most often results in a complete 360 degree spin. If there is structure on both sides so narrow as to disallow a spin, the weight will follow the line, sliding along on the angled portion of the weight until clearance is achieved. If the passage is to narrow and snags the weight, then the strong all metal construct of the weight is a particular asset in freeing the weight by intense applied force. This weight is designe to be attached at the tag end of the line in a fixed non-sliding fashion.

### DESCRIPTION OF DRAWING

FIG. 1. Is a 1″ long swivel, used as an intermediary means of line attachment,to various other fishing apparatus for the purpose of eliminating line twist.

FIG. 2. Is a 3/8″ O ring, used as a means of attaching line or swivel to various other fishing apparatus.

FIG. 3. Is a front view of a hole fashioned as a means of line attachment to the weight. Said hole is 1/8″ in diameter and resides 1/16″ of an inch from the tip of the angled end of said weight Said hole is horizontal and at a right angle to the length of the weight after a 40 degree angle has been fashioned.

FIG. 4. Is a left side view of the body of the weight, which is 6″ long and 1/4 inch in diameter. Said weight is made of iron and weighs about 1½ ounces.

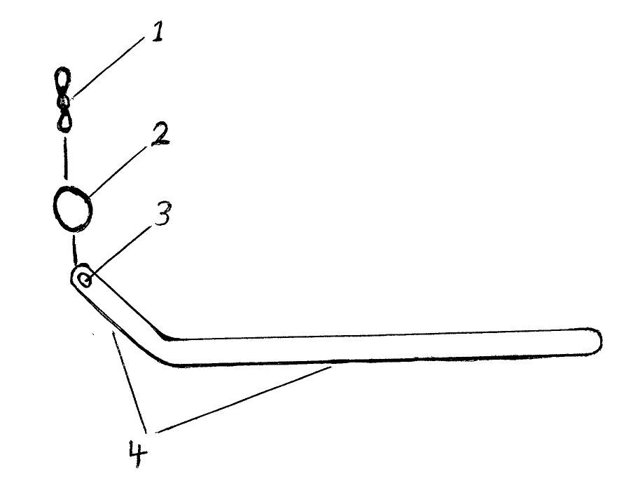

1. I claim a Dynamic Snag Resistant Fishing Weight comprising:
(A) a hard round metal weight 6″ inches long and 1/4″ inch in diameter have both ends rounded to
(B) a hemisphere head with
(C) a hole 1/8″ in diameter drilled through said weight near the tip of one said hemisphere head leaving approximatley 1/16 of an inch of metal between the edge of said hole and the end of said tip which is 1½ inches from
(D) a bend forming a sharp angle of 40 degrees which causes a snag resistant spin manuever by said weight upon impact with obstacles.

2. The weight of claim 1a wherein there is a metal weight said metal weight is made of iron.

3. The weight of claim 2 wherein there is a metal weight made of iron said iron weighs about 1.50 ounces.

4. The weight of claim 1c wherein there is a hole 1/8″ inch in diameter said hole is attached through by a 3/8″ o ring.

5. The weight of claim 4 wherein a hole 1/8″ inch in diameter is attached through by a 3/8″ o ring said o ring is attached through by a 1″ long swivel.
